(19) United States
(12) Patent Application Publication
(10) Pub. No.: US 2021/0086411 A1
(43) Pub. Date: Mar. 25, 2021

(54) INTERIOR TRIM PANEL FOR A VEHICLE AND METHOD OF FORMING SAME

(71) Applicant: GM GLOBAL TECHNOLOGY OPERATIONS LLC, Detroit, MI (US)

(72) Inventors: William R. Rodgers, BLOOMFIELD TOWNSHIP, MI (US); Robert Joseph Reuter, Novi, MI (US); Xiaosong Huang, Novi, MI (US); Timothy M. Boundy, Rochester, MI (US); Robert J. Schlenke, Fenton, MI (US); Brian McPeck, Macomb, MI (US)

(21) Appl. No.: 16/580,698

(22) Filed: Sep. 24, 2019

(51) Int. Cl. B29C 43/18; B32B 3/26; B32B 9/02; B29C 43/20

(52) U.S. Cl. CPC B29C 43/184; B32B 3/263; B32B 9/025; B29K 2711/08; B32B 2307/732; B32B 2605/003; B29C 43/203

(57) ABSTRACT

An interior trim panel for a vehicle includes a leather layer defining a feature having a radius of less than five millimeters, and a backing layer adhered to the leather layer and providing a support structure for the leather layer. A method of forming the interior trim panel includes clamping the leather layer in a frame to securely fix the edges of the leather layer, positioning the leather layer between compression mold dies defining a complementary surface having a feature with a radius of less than five millimeters, and compressing the leather layer between the dies.

### FIELD

The present disclosure relates to an interior trim panel for a vehicle and method for forming the interior trim panel.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicle interior trim panels may form a part of a vehicle interior such as, for example, an instrument panel, a door panel, a glove box door, an armrest, a headrest, a knee bolster and the like. These vehicle interior trim panels may have a leather surface layer which may be aesthetically pleasing to vehicle occupants. Conventionally, vehicle interior trim panels having a leather surface layer are formed by applying a leather layer to an underlying supporting substrate. The supporting substrate may incorporate a decorative surface that, when covered by a leather surface layer, provides a desirable aesthetic appearance. The leather surface layer is hand laid over the supporting substrate and then pushed, pulled, tucked and pinched into the decorative contour of the underlying supporting substrate. The leather surface layer may then be secured to the underlying supporting substrate using adhesives and/or mechanical fastening systems. The cost of producing these vehicle interior trim panels having a leather surface layer is expensive and time consuming. Further, there are significant limitations on the ability of these conventional processes to provide a vehicle interior trim panel with a leather surface layer that defines a feature having a radius of less than five millimeters. It is desirable to provide a vehicle interior trim panel having a leather surface layer with a decorative surface that includes a feature with a radius of less than five millimeters. Preferably, it is desirable to provide a vehicle interior trim panel having a leather surface layer with a decorative surface that includes a feature with a radius of less than three millimeters and it is even more desirable to provide a vehicle interior trim panel having a leather surface layer with a decorative surface that includes a feature with a radius of less than one millimeter.

### SUMMARY

In an exemplary aspect, an interior trim panel for a vehicle includes a leather layer defining a feature having a radius of less than five millimeters, and a backing layer adhered to the leather layer and providing a support structure for the leather layer.

In another exemplary aspect, the leather layer has a first thickness of less than five millimeters adjacent the feature.

In another exemplary aspect, the leather layer has a second thickness that is larger than five millimeters spaced away from the feature.

In another exemplary aspect, the feature has a radius of less than three millimeters, the leather layer has a first thickness of less than three millimeters adjacent the feature, and a second thickness that is larger than three millimeters spaced away from the feature.

In another exemplary aspect, the feature has a radius of less than two millimeters, the leather layer has a first thickness of less than two millimeters adjacent the feature, and a second thickness that is larger than two millimeters spaced away from the feature.

In another exemplary aspect, the feature has a radius of less than one millimeter, the leather layer has a first thickness of less than one millimeter adjacent the feature, and a second thickness that is larger than one millimeter spaced away from the feature.

In another exemplary aspect, a method of forming an interior trim panel for a vehicle includes providing a leather layer having a first thickness greater than five millimeters, clamping the leather layer in a frame to securely fix the edges of the leather layer, positioning the leather layer between a first compression molding die and a second compression molding die, and compressing the leather layer between the first compression molding die and the second compression molding die such that the leather layer stretches locally adjacent to the feature and reduces the thickness of the leather layer to a second thickness that is less than five millimeters adjacent the feature. The frame is positioned outside of the periphery of both the first and second compression molding dies, and the first compression molding die and the second compression molding dies define a complementary surface that includes a feature having a radius of less than five millimeters.

In another exemplary aspect, the feature has a radius of less than three millimeters and the second thickness is less than three millimeters adjacent the feature.

In another exemplary aspect, the feature has a radius of less than two millimeters and wherein the second thickness is less than two millimeters adjacent the feature.

In another exemplary aspect, the feature has a radius of less than one millimeter and wherein the second thickness is less than one millimeter adjacent the feature.

In another exemplary aspect, further includes providing a backing layer to the leather layer.

In another exemplary aspect, providing the backing layer includes positioning the backing layer between the leather layer and one of the first compression molding die and the second compression molding die before compressing the leather layer.

In another exemplary aspect, providing the backing layer includes providing the backing layer to the leather layer before clamping the leather layer in the frame.

In another exemplary aspect, providing the backing layer includes providing the backing layer to the leather layer after compressing the leather layer.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of an exemplary method of forming a vehicle interior trim panel in accordance with the present disclosure;

FIG. 2 is a close-up view of a feature of an exemplary vehicle interior trim panel in accordance with the present disclosure;

FIG. 3 is a flowchart of an exemplary method of forming a vehicle interior trim panel in accordance with the present disclosure; and

FIG. 4 is a close-up cross-sectional view of another feature of an exemplary vehicle interior trim panel in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

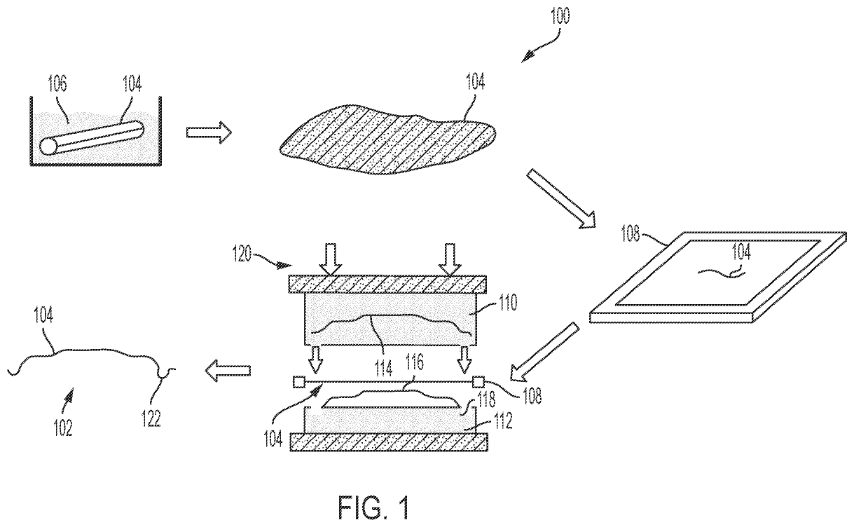

Referring now to the drawings, wherein like reference numbers correspond to like or similar components throughout the several figures, FIG. 1 is a schematic illustration of an exemplary method 100 of forming a vehicle interior trim panel 102 in accordance with the present disclosure. The exemplary method optionally starts by soaking a leather article 104 in a solution 106 that enhances the pliability of the leather article 104 in preparation for the subsequent stretching and molding operations. Preferably, the leather article 104 has a thickness of greater than five millimeters. Alternatively, the leather article 104 may have a thickness of less than five millimeters. It is to be understood that the soaking step is optional and may not be necessary for practicing the method disclosed herein. The leather article 104 may be sufficiently pliable without soaking in a solution 106. The leather article 104 may then be removed from the solution and clamped within a frame 108 that fixes and holds the edges of the leather article 104. Next, the leather article 104 and clamping frame 108 is positioned between a first compression molding die 110 and a second compression molding die 112 of a compression mold 120. The clamping frame 108 extends outside of the outer peripheral extent of the first and second compression molding dies 110 and 112. Each of the first compression molding die 110 and the second compression molding die 112 define complementary surfaces 114 and 116, respectively. Additionally, the complementary surfaces 114 and 116 define a feature 118 having a radius of less than five millimeters.

Next, the first and second compression molding dies 110 and 112 are brought together placing the leather article 104 under compression between them. The unique inventive combination of holding the edges of the leather article 104 fixed in a frame 108 and the complementary surfaces 114 and 116 defining a feature 118 having a radius of less than five millimeters causes a localized stretching of the leather article 104 such that the thickness of the leather article 104 adjacent to the feature 118 is reduced to a thickness of five millimeters or less. In this manner, the leather article 104 is able to conform to a feature having a very tight radius such as, for example, a radius of less than five millimeters. The first compression molding die 114 and the second compression molding die 116 may be at room temperature or heated. Optionally, the temperatures of the first compression molding die 110 and the second compression molding die may be higher than 50° C. and lower than 150° C., or more optimally higher than 85° C. and lower than 115° C. yet further optionally higher than 95° C. and lower than 105° C. In the case of the use of a soaking step, heating the compression molding dies may assist with the removal of the solvent from the leather. In the case where the soaking step is not used, heating the compression molding dies may make the leather substrates more pliable.

Next, the compression mold 120 is opened and the clamping frame 108 is removed from the leather article 104. In this manner, the inventive process forms a feature 122 having a radius of less than five millimeters in the leather article 104 which may then be positioned in a vehicle as a vehicle interior trim panel.

Optionally, a backing layer (not shown) may be provided which assists the shaped leather article in maintaining the shape that was established during the stretching and forming during the compression molding operation. A backing layer may be provided to the leather article before, during, or after the compression molding operation. If the backing layer is provided during the compression molding operation an exemplary material forming the backing layer may include a polymer such as, for example, thermoplastic polymers chosen from the group of polyvinyl chloride, polyvinylidene chloride, polyvinyl acetate, polyvinyl alcohol, polystyrene, acrylonitrile-styrene polymer, acrylonitrile-butadiene-styrene resin, polyacrylate resin, polymethacrylate, polyethylene, polypropylene, polyamide (PA46, PA6, PA66, PA11, PA12, PA610), fully or partially aromatic polyamide resins, polyacetal resin, polybenzimidazole, polycarbonate, polyethylene terephthalate, polyethylene naphthalate, polyethylene terephthalate, polybutylene terephthalate, polyphenyl ethers, polyphenylene oxides, polyphenylene sulfide, polyethersulfones, polyetherether ketones, polyether ketones, polyetherimides, polylactides, polyoxymethylenes, thermoplastic polyurethanes, or any combination or copolymer of these resins without limitation. One or more of these polymers may be formed into a backing layer and heated above their respective melting point and then co-molded together with the leather article.

Alternatively, a thermoset polymer may be provided as a backing layer and may be applied, for example, by spraying onto a surface of the leather article prior to clamping in the clamping frame. The backing material may also be provided as an uncured or b-staged sheet which is clamped into the frame along with the leather layer. These materials would then be formed and cured during the compression molding operation. Exemplary thermoset material that may be useful as a backing layer includes, for example, may include: benzoxazine, a bis-maleimide (BMI), a cyanate ester, an epoxy, a phenolic (PF), a polyacrylate (acrylic), a polyimide (PI), an unsaturated polyester, a polyurethane (PUR), a vinyl ester, a siloxane, or any combination or copolymer of these resins without limitation.

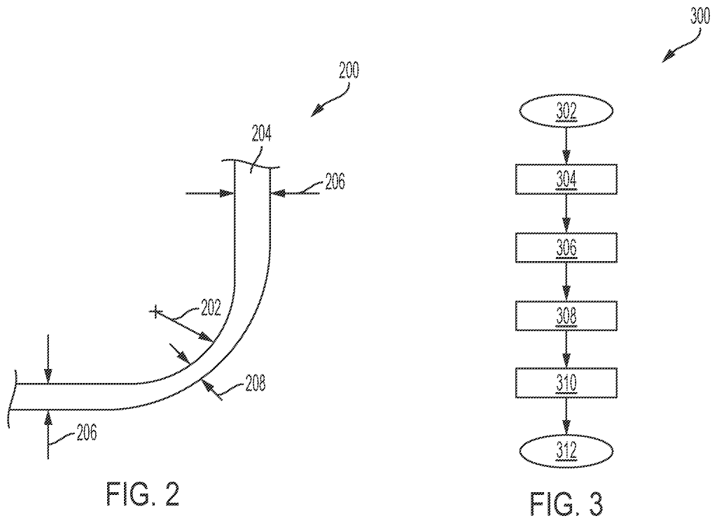

FIG. 2 is a close-up view of a feature of an exemplary vehicle interior trim panel 200 in accordance with the present disclosure. The feature radius 202 of the trim panel 200 is less than five millimeters. The vehicle interior trim panel 200 includes a leather layer 204 having a thickness 208 that is less than five millimeters adjacent to the feature. Preferably, the leather layer 204 may also include portions which are spaced away from the feature having a thickness 206 of greater than five millimeters. More preferably, the feature radius 202 is less than three millimeters and the leather layer thickness 208 is less than three millimeters. Even more preferably, the feature radius 202 is less than two millimeters and the leather layer thickness 208 is less than two millimeters. Yet more preferably, the feature radius 202 is less than one millimeter and the leather layer thickness 208 is less than one millimeter. The feature radius 202 of less than five millimeters is made possible by forming the vehicle interior trim panel 200 in accordance with the method described previously with reference to FIG. 1. In any case, the exemplary method of the present disclosure enables a feature having a radius which is less than the thickness of the leather layer by locally stretching the leather to a reduced thickness at the feature. In this manner, the present invention enables very sharp features in a vehicle interior trim panel having a leather layer that was previously not possible.

FIG. 3 illustrates a flowchart 300 of an exemplary method of forming a vehicle interior trim panel having a leather layer with a feature radius of less than five millimeters in accordance with the present disclosure. The method starts at step 302 and continues to step 304 where a leather layer having a first thickness greater than five millimeters is provided. The method then continues to step 306 where the leather layer is clamped in a clamping frame to securely fix the edges of the leather layer. Next the method continues to step 308 where the leather layer is positioned between a first compression molding die and a second compression molding die and the frame is positioned outside of the periphery of both the first and second compression molding dies. The first compression molding die and the second compression molding dies define a complementary surface that includes a feature having a radius of less than five millimeters. The method then continues to step 310 where the leather layer is compressed between the first compression molding die and the second compression molding die such that the leather layer stretches locally adjacent to the feature and reduces the thickness of the leather layer to a second thickness that is less than five millimeters adjacent the feature. The method then continues to step 312 where the mold is opened and the method of forming a vehicle interior trim panel having a feature with a radius of less than five millimeters is complete.

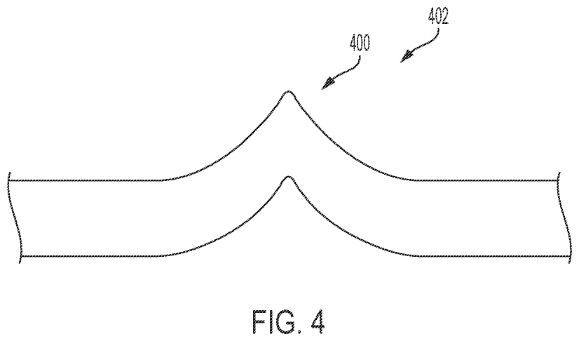

FIG. 4 is a close-up cross-sectional view of another feature 400 of an exemplary vehicle interior trim panel 402 in accordance with the present disclosure. The feature 400 provides a sharp crease line in the vehicle interior trim panel 402. This is in contrast to the features illustrated previously in the present disclosure which generally formed a corner. It is to be appreciated that the term “feature” as used herein is intended to incorporate any shape for the vehicle interior trim panel which may be formed by the inventive aspect of localized stretching of a leather layer to thickness of less than five millimeters.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An interior trim panel for a vehicle comprising:
a leather layer defining a feature having a radius of less than five millimeters; and
a backing layer adhered to the leather layer and providing a support structure for the leather layer.

2. The trim panel of claim 1, wherein the leather layer has a first thickness of less than five millimeters adjacent the feature.

3. The trim panel of claim 2, wherein the leather layer has a second thickness that is larger than five millimeters spaced away from the feature.

4. The trim panel of claim 1, wherein the feature has a radius of less than three millimeters, and wherein the leather layer has a first thickness of less than three millimeters adjacent the feature and a second thickness that is larger than three millimeters spaced away from the feature.

5. The trim panel of claim 1, wherein the feature has a radius of less than two millimeters, and wherein the leather layer has a first thickness of less than two millimeters adjacent the feature and a second thickness that is larger than two millimeters spaced away from the feature.

6. The trim panel of claim 1, wherein the feature has a radius of less than one millimeter, and wherein the leather layer has a first thickness of less than one millimeter adjacent the feature and a second thickness that is larger than one millimeter spaced away from the feature.

7. A method of forming an interior trim panel for a vehicle, the method comprising:
providing a leather layer having a first thickness greater than five millimeters;
clamping the leather layer in a clamping frame to securely fix the edges of the leather layer;
positioning the leather layer between a first compression molding die and a second compression molding die, wherein the frame is positioned outside of the periphery of both the first and second compression molding dies, and wherein the first compression molding die and the second compression molding dies define complementary surfaces that each include a feature having a radius of less than five millimeters; and
compressing the leather layer between the first compression molding die and the second compression molding die such that the leather layer stretches locally adjacent to the feature and reduces the thickness of the leather layer to a second thickness that is less than five millimeters adjacent the feature.

8. The method of claim 7, wherein the feature has a radius of less than three millimeters and wherein the second thickness is less than three millimeters adjacent the feature.

9. The method of claim 7, wherein the feature has a radius of less than two millimeters and wherein the second thickness is less than two millimeters adjacent the feature.

10. The method of claim 7, wherein the feature has a radius of less than one millimeter and wherein the second thickness is less than one millimeter adjacent the feature.

11. The method of claim 7, further comprising providing a backing layer to the leather layer.

12. The method of claim 11, wherein providing the backing layer comprises positioning the backing layer between the leather layer and one of the first compression molding die and the second compression molding die before compressing the leather layer.

13. The method of claim 11, wherein providing the backing layer comprises providing the backing layer to the leather layer before clamping the leather layer in the frame.

14. The method of claim 11, wherein providing the backing layer comprises providing the backing layer to the leather layer after compressing the leather layer.

15. The method of claim 11, further comprising soaking the leather layer in a solution prior to clamping the leather to increase the pliability of the leather layer.

16. An interior trim panel for a vehicle formed by the method comprising:
providing a leather layer having a first thickness greater than five millimeters;
clamping the leather layer in a frame to securely fix the edges of the leather layer;
positioning the leather layer between a first compression molding die and a second compression molding die, wherein the frame is positioned outside of the periphery of both the first and second compression molding dies, and wherein the first compression molding die and the second compression molding dies define a complementary surfaces that each include a feature having a radius of less than five millimeters; and
compressing the leather layer between the first compression molding die and the second compression molding die such that the leather layer stretches locally adjacent to the feature and reduces the thickness of the leather layer to a second thickness that is less than five millimeters adjacent the feature.

17. The method of claim 16, wherein the feature has a radius of less than three millimeters and wherein the second thickness is less than three millimeters adjacent the feature.

18. The method of claim 16, wherein the feature has a radius of less than two millimeters and wherein the second thickness is less than two millimeters adjacent the feature.

19. The method of claim 16, wherein the feature has a radius of less than one millimeter and wherein the second thickness is less than one millimeter adjacent the feature.

20. The method of claim 16, further comprising providing a backing layer to the leather layer.
